(19) United States
(12) Patent Application Publication
(10) Pub. No.: US 2011/0239917 A1
(43) Pub. Date: Oct. 6, 2011

(54) BAIT GRANULE PRODUCTION METHOD

(75) Inventor: Xavier Peyron, Marseille (FR)

(73) Assignee: SBM Development, Eculy (FR)

(21) Appl. No.: 13/001,518

(22) PCT Filed: Jun. 24, 2009
(86) PCT No.: PCT/FR2009/000771

§ 371 Date: Jun. 20, 2011

(30) Foreign Application Priority Data
Jun. 25, 2008 (FR) 08/03577

(51) Int. Cl. A01N 25/12; A01M 99/00; A01C 5/00; A01C 7/00; A01N 53/08; A01P 7/04

(52) U.S. Cl. 111/14; 43/124; 424/84; 424/405

(57) ABSTRACT

The subject matter of the invention is a solid insecticidal bait in the form of granules, comprising at least pyrethrum and a carrier, and also a method for producing said bait and a method for applying said bait.

The present invention relates to the field of agriculture, and more particularly to a novel insecticide composition in the form of bait, advantageously based on pyrethrum.

The term pesticide, derived from the word pest, denotes substances or preparations used for the prevention, control or eradication of organisms considered to be undesirable, whether they are plants, animals, fungi or bacteria. In common parlance the term pesticide is generally associated with the agricultural use of these substances, but the generic term also includes domestic and municipal uses, use for road maintenance etc.

In the present text, the term pesticide denotes either the active ingredient, i.e. responsible for the intended action, and the composition containing the active ingredient and sold to the user. In the field of agriculture, they are called phytopharmaceutical products (or plant protection products). There are basically three categories: herbicides (to control weeds), fungicides (to control fungi) and insecticides (to control insects). There are other products having action on rodents (rodenticides), and on snails and slugs (molluscicides).

Pesticides have been used in agriculture since ancient times. The use of sulphur appears to date back to 1000 years B.C., arsenic was recommended by Pliny and the arsenical products have been known in China since the XVI century; the insecticidal properties of tobacco and of roots of Derris and of Lonchocarpus were also noted around that era.

The more generalized use of pesticides followed advances in inorganic chemistry. In the XIX century, fungicidal treatments were based on copper sulphate (including the famous Bordeaux mixture) or based on mercury; insecticides such as copper arsenite, copper acetoarsenite, and lead arsenate also made their appearance. Pyrethrum, a powder obtained from flowers of the genus Chrysanthemum, was introduced as an insecticide in this same period.

Then, pesticides received a considerable boost with the development of organic chemistry even before World War II; and especially thereafter. It was in this period that a large number of organic compounds appeared.

In the 1950s, insecticides such as DDD and DDT were used in large quantities in preventive medicine for destroying the mosquito responsible for malaria and in agriculture for eradicating the Colorado beetle.

There has been considerable development in the use of these products in recent decades, making them almost indispensable for most agricultural practice, regardless of countries' levels of economic development. From 1945 to 1985, the consumption of pesticides doubled every ten years.

Among the pesticides, insecticides are the active ingredients or preparations having the property of killing insects, their larvae and/or their eggs. The generic term insecticide also includes pesticides intended to control arthropods, which are not insects (e.g. mites, spiders or tics), as well as repellents.

There are various chemical classes of insecticides, which are related to their mode of action, which may be based on disturbance of the nervous system, of cellular respiration, the formation of the cuticle, or disturbance of moulting. These main classes are the organophosphorus compounds, the carbamates, the natural or synthetic pyrethroids, the organochlorine compounds and the benzoyl ureas.

Among the various uses of insecticides, the protection of seedlings against soil insects is still crucial for certain crops. The year 2006 marks an upsurge in damage caused by underground pests, for example grey fly, and click beetles. The latter were extremely prevalent in the autumn of 2005 to some extent everywhere and more particularly in the west of France. Only protection of seeds provides an effective response against these pests.

Crops of maize, beetroot, sunflower, potato and colza are still very liable to destruction by the click beetle, and the almost complete destruction of plots is sometimes observed in the absence of treatment. The click beetles constitute a family of insects that are particularly harmful to these crops, and their harmful character is even more pronounced as the larval forms of the click beetles can remain in the soil for very long periods of up to 5 years.

Although pesticides have made an enormous contribution to the management of food resources and improvement of public health (in particular for controlling disease-carrying insects), the other side of the coin soon appeared with the development of resistance in insects, sex change in certain batrachians and fertility problems in certain invertebrates.

Pollution with pesticides has been detected in all compartments of the environment: in river water and groundwater, in the air and in rein water. They are also found in fruit, vegetables, cereals and products of animal origin (eggs, milk, meat, fish etc.). They exist in their initial form but they may also be degraded, and are then called residues or metabolites.

Thus, although insecticides have been adopted, they still give rise to disquiet in particular because of the environmental problems connected with their misuse. An agent is still sought that can effectively control “pests” yet displays the minimum possible toxicity, or even no toxicity of all.

In most countries the marketing and use of insecticides are subject to prior authorization (approval or marketing authorization) by the competent national authority.

For many years, numerous plant protection products previously authorized (and therefore considered as effective and not presenting unacceptable risks) have been banned or are going to be banned from marketing and use, for example atrazine, lindane, and DDT.

Those that are still on the market offer the advantage that either they are less toxic, or they are highly active, and can thus be spread at low dose, which avoids not only the pollution mentioned above, but also problems of costs associated with spreading large quantities of insecticide.

However, the European overall programme of ecological reform of agriculture envisages banning, from 2008, nearly 400 products that are judged to be dangerous to human health, although they had been approved by the 1991 directive.

There is therefore a constant real need for active ingredients that are more effective and less harmful, for formulations that are more effective, or for methods of application optimizing the “contacting” of the pesticide with the plant and/or with the harmful animal.

At present, throughout the world there are nearly 100,000 commercial specialities authorized for sale, comprising about 800 different active ingredients. 15 to 20 new active ingredients are added each year.

The main types of formulation are as follows:
Solid presentations:
   wettable powders (WP): the active ingredient is finely ground (solid) or fixed (liquid) on an adsorbent or porous support (silica). Surfactants (dodecylbenzene sulphonate, lignosulphonate of Ca, Al or Na) and diluting fillers (kaolin, talc, chalk, aluminium and magnesium silicate or calcium carbonate) are added, as well as antiredeposition agents, antistatic or anti-foaming agents. Stabilizers (anti-oxygen and pH buffer) are included to make them compatible with other preparations. These powders must be dispersed in water at the moment of use;
   water dispersible granules (WG): granules obtained by agglomeration with a little water, active ingredient, filler and binders and dispersants, followed by drying. These granules must be dispersed in water at the moment of use;
   microgranules (MG): granules obtained by agglomeration of active ingredient, filler and binders and dispersants, followed by drying. The microgranules are formulated to be used dry and are ready to use. They are calibrated and have a uniform size to permit even spreading of the active ingredient. The filler is a mineral filler;
   granular bait (GB): granules obtained by agglomeration of active ingredient, filler and binders and dispersants, followed by drying. Granular bait is formulated ready to use. It is calibrated and has a uniform size to permit even spreading of the active ingredient. The filler is a flour (wheat, durum wheat, etc.). The invention relates very particularly to this type of formulation.
Liquid presentations:
   soluble concentrates (SL): this is a solution of active ingredient to be diluted in water, with added surfactants;
   concentrated suspensions (SC): the solid active ingredients, insoluble in water, are in concentrated suspension in water, in the presence of wetting agents, dispersants, thickeners (xanthan gum, bentonite, silica) or anti-redeposition agent, antigelling agent (ethylene glycol, urea), antifoaming agents and sometimes bactericides (1,2-benzisothiazol-3(2H)-one, methanal or formol). These preparations are diluted in water at the moment of use;
   emulsifiable concentrates (EC): a concentrated solution of the active ingredients is prepared in an organic solvent and emulsifiers are added for stabilizing the emulsions obtained at the moment of use by dilution in water;
   concentrated emulsions (EW): the active ingredient is dissolved in an organic solvent. The solution, to which emulsifiers are added, is dispersed in a large quantity of water. This presentation is less toxic and less flammable than the emulsifiable concentrates. It is diluted in water at the moment of use.

The pesticides can be sold as powders or as concentrates to be diluted with water, as aerosol, granules or bait. They are applied in various ways; they can be sprayed from an aircraft or from a sprayer optionally drawn by a tractor, dissolved in water for irrigation, ploughed into the soil, spread as granules or as pellets on the soil near the plants, applied as treatment of seeds, inserted in the collar of cattle or presented in the form of bait.

The active ingredient of the pesticides is not generally used in pure form: within the scope of the present invention it is combined with a foodstuff serving as bait, the support, advantageously flour, for example wheat flour or maize flour, and more particularly durum wheat flour.

Unexpectedly, to the best of the applicant's knowledge, baits based on an active ingredient, advantageously pyrethrum, particularly those in the form of granules, is not known. As the pyrethrums are compounds that act by contact, and not by the effect of the vapour, they are usually used in a liquid formulation. They are not used in a bait formulation or as bait granules, because if applied conventionally, i.e. at the bottom of the seed furrow or on the surface, their effect remains very localized and very limited.

Even so, this formulation has many advantages, and in particular, as the active ingredient is integrated in the bait owing to its manner of preparation including a step of intimate mixing of the active ingredient and the support, its useful life is extended relative to conventional granules in which the active ingredient is only adsorbed on the surface of said granules. This leads to improved efficacy of the insecticide for an equivalent dose of active ingredient, since its degradation is delayed as a result of the protection afforded by the intimate mixing with the support.

This led the applicant to develop a novel bait, which can comprise an insecticidal active ingredient and a support, said bait advantageously being in the form of granules (bait granules).

Therefore one of the purposes of the present invention is to provide a novel insecticidal bait, as well as the method of preparation thereof and the manner of application thereof. In particular, according to the invention, the bait can be in the form of granules, this form being associated with the particular manner of preparation that can be used for producing said bait. Even more advantageously the active ingredient of the bait according to the invention can be pyrethrum.

Hereinafter, unless stated otherwise, the term pyrethrum denotes pyrethrum per se, pyrethrins and/or pyrethroids, whether they are natural or synthetic, as well as all their isomers or mixtures of isomers. However, the invention, as will be seen hereunder, relates to a bait the active ingredient of which can be an insecticidal compound, advantageously pyrethrum.

The pyrethrum, or Dalmatian pyrethrum, is a hardy herbaceous plant of the family Compositae. It is a species that originated from south-east Europe (Croatia, Montenegro, Albania). It is a hardy plant that grows to a height of 40 to 60 cm, growing in clumps with numerous stems each bearing a terminal capitulum. It has been spread widely by cultivation, in particular in Europe (Italy, Spain), to Japan, North Africa, Kenya, and Rwanda. This plant is cultivated for its flowers, from which an insecticidal powder is extracted.

The term “pyrethrum per se” denotes the powder made from the dried flowers of chrysanthemum whereas the term “pyrethrin(s)” denotes the six insecticidal compounds contained naturally in this powder and well known to a person skilled in the art. These six pyrethrins constitute from 0.9 to 1.3% of the dried flowers. Commercially, purification of the pyrethrins is generally attempted. After the initial extraction, refining is carried out to remove the resins, waxes and allergens. The extract is then used in the preparation of various insecticides. This complex industrial process optimizes the efficacy of the product. Adjuvants can be added, to increase the efficacy of pyrethrum, or surfactants, or antioxidants.

As well as these natural insecticidal compounds, there is a whole range of synthetic pyrethroids, which are inexpensive and very effective.

The pyrethroids represent one of the rare families of insecticidal compounds that still have marketing authorization, and in particular for protecting seeds.

The synthetic pyrethroids are called “third generation” insecticides; they were derived from natural pyrethrums, while endeavouring to increase their toxicity and their photostability. Endowed with considerable toxicity and acting by contact, they kill insects almost instantaneously by neurotoxic shock, so that they can be used at very low doses (10 to 40 g of active ingredient per hectare). They kill insects by blocking the functioning of the sodium channels, which are indispensable to the transmission of nerve impulses.

Reputed to be of low toxicity for humans, they are attributed the highest safety factor (ratio of toxicity to insects to toxicity to mammals) among the chemical insecticides. Being very biodegradable, they do not persist in the soil, but these compounds are toxic to certain aquatic organisms and to aids to agriculture, such as bees.

Examples of synthetic pyrethroids are: acrinathrin, bifenthrin, bioresmethrin, alphametrine, deltamethrin, depallethrin, etofenprox, fenpropathrin, cypermethrin, fenvalerate, esfenvalerate, cyfluthrin, betacyfluthrin, betacypermethrin, tralomethrin, fluvalinate, tau-fluvalinate, permethrin, lambda-cyhalothrin, flucythrinate, tefluthrin, zetacypermethrin.

Thus, the invention relates to a solid insecticide in the form of bait, comprising at least one active ingredient and a support. Advantageously according to the invention, the bait can be in the form of granules. The product can then be called bait granules.

According to the invention, the active ingredient can be selected from pyrethrum, neonicotinoids (for example thiamethoxam, clothianidine), chloronicotiniles (for example acetamiprid, imidacloprid, thiacloprid), spinosoids (for example spinosad), the pyridine-azomethrins (for example pyrimetrozine), the pyridine-carboxamides (for example flonicamid), azadirectins, and said compounds can be natural or synthetic. The invention also relates to all the isomers or mixtures of isomers of said compounds.

Advantageously according to the invention, the active ingredient can be selected from pyrethrum (pyrethrum per se, pyrethrins and/or pyrethroids).

The bait according to the invention can comprise, as active ingredient, one of the aforementioned compounds, alone, or any mixture thereof. Advantageously the bait can also comprise, independently or simultaneously, pyrethrum per se and/or one or more pyrethrins and/or one or more pyrethroids.

Optionally, according to the invention, the bait can comprise, in addition to pyrethrum, one or more other pesticide compounds.

Advantageously, apart from pyrethrum per se and pyrethrins, the synthetic pyrethroids can be selected from acrinathrin, bifenthrin, bioresmethrin, alphametrine, deltamethrin, depallethrin, etofenprox, fenpropathrin, cypermethrin, fenvalerate, esfenvalerate, cyfluthrin, betacyfluthrin, betacypermethrin, tralomethrin, fluvalinate, tau-fluvalinate, permethrin, lambda-cyhalothrin, flucythrinate, tefluthrin, zetacypermethrin.

Preferably according to the invention, the bait can advantageously comprise cypermethrin and/or natural pyrethrum.

According to the invention, the support can be any support usually used for the preparation of bait (for example wheat flour, durum wheat flour, maize flour), Advantageously according to the invention the support can be wheat flour or bran flour or durum wheat flour or maize flour. Preferably according to the invention, durum wheat flour can be used.

According to the invention the bait can comprise an active ingredient in a proportion between 2 and 12 grams of active ingredient per kilogram of composition, preferably between 6 and 10 g/kg, and very preferably between 7 and 9 g/kg.

According to the invention the bait can comprise a support in a proportion between 800 and 998 g per kilogram of composition, preferably between 900 and 990 g/kg, and very preferably between 975 and 985 g/kg.

According to the invention, the bait can have a diameter between 0.5 and 3 mm, preferably between 1 and 2 mm, and very preferably a diameter of 1.6 mm.

The apparent density of the bait is important as it determines good spreading of the bait. Thus, according to the invention, the bait can have an apparent density between 0.40 and 1, preferably between 0.60 and 0.90.

By “apparent density” is meant the ratio of the weight of the sample to the volume of said sample (ad=W/V). (YORO G. and GODO G., Cah. ORSTOM, sér. Pédol., Vol. XXV, No. 4, 1989-1990: 423-429).

The bait according to the invention is small in comparison with the products of the same type, which means it can have a large number of grains per gram. Thus, the product is well distributed in the soil, which increases its efficacy since the probability of contact between the granules and the pests is increased.

Thus, according to the invention the bait can have a number of grains per gram between 250 and 600, preferably between 300 and 450.

According to the invention, the application dose of the bait can vary depending on the compound used.

According to the invention, the bait can be used at a dose in the range from 2 to 20 kg/ha, preferably from 9 to 15 kg/ha, and very preferably of 12 kg/ha.

A person skilled in the art will readily understand that the bait according to the invention can further comprise any other compound usually used in this industry (anti-mould agents, bittering agents, repellents, lubricants, attractants etc.).

It is also possible to add, to the bait according to the invention, other additives such as a bittering agent, for example denatonium benzoate or an olfactory repellent (to prevent ingestion of the granules by animals).

It is also possible to add, to the bait according to the invention, preservatives for preventing the development of undesirable contaminating and/or pathogenic agents that could be generated by the combination of dampness and organic matter, for example the formation of moulds. In this respect salicylic acid or dinitrophenol may be mentioned for example. Salicylic acid can be used advantageously according to the invention.

As is conventional in this field, the bait according to the invention can further comprise a dye that a person skilled in the art will select as a function of its constraints from the dyes usually used. By way of example Hostaperm Blue B2G-KR from Clariant may be mentioned, which is a blue dye that is used advantageously because birds only perceive this colour very poorly, which prevents them being attracted excessively by the bait.

The quantities of supplementary additives added to the composition of the bait according to the invention are conventional in the field in question and a person skilled in the art will have no difficulty adjusting them according to the constrains encountered.

Another subject of the invention is the method of production of the bait.

In fact, in order to obtain the best possible results in terms of efficacy with the bait according to the invention, it is important that the granules are perfectly calibrated and therefore very uniform in size. When this criterion is satisfied, this facilitates application of the bait on or in the soil (at the surface or at a depth) and permits better control of the dose applied. However, a person skilled in the art is perfectly aware that this criterion, though important, is not limiting.

Even if the bait according to the invention were to be manufactured by a production method other than that recommended by the applicant, it would still display broadly sufficient efficacy, justifying its use.

That is why the inventors endeavoured to develop a method of production of the bait according to the invention that produces a bait that is perfectly calibrated.

Thus, the invention also relates to a method of production of a bait comprising at least one active ingredient and a support in which
in a first step a premix of the active ingredient with an absorption filler is produced;
in a second step an extrudable paste comprising the active ingredient is prepared with the premix obtained in step 1;
in a third step said paste obtained in step 2 is extruded and chopped, to obtain the bait in the desired form of granules;
in a fourth step the granules obtained in step 3 are dried.

Advantageously according to the invention, a fifth step can be provided, during which the dry granules obtained in step 4 are cooled.

Also advantageously, it is moreover possible to provide a sixth step, during which the cooled granules obtained in step 5 are lubricated.

Even more advantageously, it is also possible to provide a seventh step of sieving of the granules.

According to the invention, the purpose of step 1 is to transform the active ingredient from the physical state that it has in the raw state, to the state of powder in order to facilitate its application during the subsequent steps of the method. In fact the majority of active ingredients, particularly the pyrethrums, are in a resinoid or liquid state at ambient temperature that is not very compatible with easy use.

In step 1 of the production method according to the invention, a premix is obtained comprising the active ingredient in an quantity in the pure state between 25 and 75%, preferably between 45 and 55%, advantageously equal to 50% by weight of the total weight of the premix.

According to the invention, step 2 of the method of production of the bait has the purpose of obtaining a powder that is as uniform as possible. For this purpose, according to the invention, step 2 of the method can be subdivided into 3 substeps, namely
a substep 2a) of preparation of a solid mixture comprising the premix obtained in step 1 and the other ingredients included in the final composition of the bait according to the invention, including in particular the support;
a substep 2b) of moistening of the solid mixture obtained in substep 2a);
a substep 2c) of kneading of the product obtained in step 2b) to obtain the extrudable paste in step 3 of the method of production of the bait according to the invention.

According to the invention, the solid mixture in substep 2a) can be prepared by all methods usually used. Advantageously according to the invention, it will be possible to use a mixer of the Lödige® type, or by extension, any plough-blade mixer, so as to obtain a homogeneous powder. Less preferably, a ribbon mixer can also be used.

According to the invention, the purpose of step 2b) is to prepare a paste having a consistency suitable for subsequent processing by extrusion. This step requires the use of a high-speed mixer in which the powder obtained in substep 2a) is mixed and homogenized with a known and controlled flow rate of moistening agent. According to the invention said moistening agent can be water or steam, advantageously water.

According to a variant according to the invention, when the moistening agent is steam, the latter can be introduced directly during step 3 of the method, during transport of the extrudable paste to the extrusion grid. Thus, the substeps of step 2 of the method are performed once during step 3.

According to the invention, the moistening agent added can be heated from ambient temperature up to 90° C., and preferably to a temperature between 30 and 60° C.

According to the invention the quantity of moistening agent to be added to the mixture is to be adjusted in relation to the water supplied by the raw materials (in particular the flour) and the climatic conditions (high humidity can have an effect on the mixing process) so that the total quantity of water contained in the extrudable paste obtained at the end of step 2 of the method of production of the bait according to the invention varies between 25 and 40%, preferably 30 and 35%, and very preferably is equal to 34.5% of the total quantity of extrudable paste obtained at the end of step 2.

The residence time of the powder in the high-speed mixer must just permit incorporation of the water in the solid mixture obtained after substep 2a) before advancing to substep 2c) of kneading. In this respect it must be short. Advantageously the residence time of the powder in the mixer is short or even very short. It can be between 30 seconds and 2 minutes, and preferably is equal to 1 minute.

In a variant of the invention, certain low-content additives, such as the preservative or the bittering agent, can be incorporated in the paste after prior dilution in water. This can promote their uniform distribution in the paste.

According to the invention, step 2c) is the most important in the method since it gives a product that can be extruded correctly. The water added in the form of the moistening agent in substep 2b) will be mixed thoroughly with the solid mixture obtained in substep 2a) and will thus be incorporated in the flour. The starch and the proteins in the flour, coming in contact with the water, will allow the paste to undergo transition to the viscoelastic phase (=pasting point), a state that is necessary for imparting certain mechanical and physical properties to the paste, which can then be extruded correctly.

According to the invention, the absorption filler can be silica, bentonites or kaolins, and preferably silica.

This step can be carried out in a kneader, advantageously in a kneader having two mixing arms, for example that of the Clextral brand (formerly AFREM). The mechanical energy added to the heat generated by the shearing and the water supplied make it possible to gelatinize the starch and the proteins contained in the wheat flour and obtain the pasting point.

The kneading time is an important parameter of the method:
if it is too short, the pasting point cannot be reached, and the paste will then quickly clog the extrusion grid;
if it is too long, the paste will be too plastic, creating preferential passages through the extrusion grid, which will have the effect of generating granules of non-uniform size.

At this stage it is possible to obtain the desired kneading time by varying for is example the kneading power, while keeping the mechanical energy, defined by the speed of rotation of the mixing shafts, constant but varying the residence time.

The speed of rotation of the mixing shafts can be between 50 and 70 rpm (revolutions per minute), preferably equal to 60 rpm.

Finally the residence time can be between 10 and 60 minutes, preferably between 15 and 45 minutes.

According to the invention, in step 3 the plastic paste obtained in step 2 is conveyed by an endless screw, called the compression screw, to the extrusion head, at the outlet of which there is the extrusion grid, through which the paste is pushed.

The compression screw is housed in a barrel.

The increase in pressure is necessary to achieve transition to the viscoelastic phase. Two factors promote an increase in pressure:
said barrel can be cooled to a temperature between 20 and 30° C., preferably to 25° C.;
the core of the screw, which has a variable diameter, provides an increase in pressure as the paste advances, owing to the decrease in volume between the flights of the screw.

The extrusion pressure is all the more important as it will define the structure of the granules, and therefore their physical and ballistic properties. The extrusion pressure can be between 20 and 120 bar, preferably between 40 and 70 bar.

Extrusion can be carried out using any generally known extruder provided that it permits the elements described above to be varied. In this connection the extruders of the Clextral range (formerly AFREM) may be mentioned.

According to a variant of the invention, a drawing device can be used at the discharge end of the screw to provide better distribution of the paste entering the extrusion head. This drawing device can be, for example, a system of plates that cut the paste so that it is uniformly distributed.

The extrusion head can comprise an empty space at the discharge end of the screw before the extrusion grid. The extrusion head can be double-jacketed. It can also be heated to promote drawing of the paste, i.e. passage of the paste through the holes of the extrusion grid. The extrusion head can be preheated to a temperature between 30 and 40° C., preferably to 35° C. In fact the extrusion head must be hotter than the barrel.

The extrusion grid (or mould) is constituted by holes (or dies) with a diameter from 0.5 to 3 mm, preferably from 1 to 2 mm, and very preferably equal to 1.6 mm. The diameter of the holes determines the diameter of the granules.

The extrusion grid can be made of any material usually used for this type of equipment. For example it can be of bronze, but can additionally be equipped with inserts made of Teflon® or Arnite®. Thus, the inside surface of the holes can be constituted by Teflon® or Arnite® in order to promote passage of the paste through the holes (drawing) and to promote cohesion of the granules, which will have the effect of limiting any subsequent generation of dust, in particular during the drying step. In this step the granules are smoothed.

The friction produced by passage of the paste through the mould will provide heating of the mould until it reaches the desired operating temperature.

The extrusion grid can additionally be equipped with a pressure distributing plate which will make it possible to obtain a uniform drawing profile. In fact, the drawing speed is usually lower at the edges of the mould on account of friction, which gives a non-uniform drawing profile.

This pressure distributing plate can be defined in relation to the diameter of the mould, the flow rate and the nature of the product.

A coarse filter can also be positioned above the distributing plate in order to trap agglomerates and avoid clogging of the dies.

According to the invention, in this same step, the extruded paste, which emerges like lengths of vermicelli, can then be cut by blades using for example a multiblade cutter, which can for example comprise 2 to 8 blades. Said cutter can be positioned at the outlet of the grid, advantageously just in front of the grid.

The desired length of the granules can be obtained by adjusting the speed of rotation of the cutters. Granule length can be between 0.5 and 3 mm, preferably between 1 and 2 mm.

According to the invention, the granules obtained in step 3 can be dried. This step is also essential in the preparation of the granules. In fact, the kinetics of drying must be defined so as to obtain granules that are:
hard enough at the surface so that they do not disintegrate under the action of rain;
soft enough inside so that they are still attractive for the pests, and are easy to ingest.

The moist granules pass through a first dryer the role of which is surface drying to prevent agglomeration of the moist granules together. The “crusted” granules then pass through a second dryer that operates in the viscoelastic phase (existence of a glass transition temperature of the starch “cross-linked” in the protein network of the flour). On discharge from this second dryer, the granules are near the glass transition, which they will cross in a third dryer where the kinetics of water extraction is slower. Each dryer has eight different zones in which the temperature, moisture content and residence time are adjusted and controlled for managing the kinetics of drying.

As an example, drying can be implemented in the various dryers as follows:
Dryer 1: temperature between 40 and 80° C.—time between 3 and 5 min;
Dryer 2: temperature between 40 and 80° C.—time between 15 and 80 min;
Dryer 3: temperature between 40 and 80° C.—time between 15 and 80 min.

The final moisture content of the granules is an important parameter.

If it is too high, this will promote the appearance of moulds in the granules, the latter being mainly constituted by organic matter (flour).

If it is too low, the granules will be more friable and risk being broken more easily during transport or application.

Moreover, the moisture content of the granules has an effect on their density, and therefore on the application dose per hectare (a moister granule will be heavier, therefore at equal density a smaller number of granules will be applied, i.e. a lower close of active ingredient per hectare). It is therefore important for the latter to be well controlled.

The moisture content of the granules can be between 8 and 15%, preferably between 10 and 15%, and very preferably between 12.5 and 14%.

Because of its effect on the true density of the granules, the moisture content also has an effect on their ballistic properties and therefore on the uniformity of application.

The overall method of implementation can also guarantee the long-term integrity of the granules: extrusion and drying applied in this way endow them with good cohesion and better moisture resistance.

According to the invention, a fifth step can be provided, for cooling the dried granules obtained in the fourth step. This can prevent condensation from the hot air and agglomeration of the granules together. The cooling temperature can be ambient temperature and the residence time in the cooler can be between 3 and 5 minutes.

According to the invention, a sixth step, of lubrication, can be provided, during which the granules obtained in the fifth step can be sprayed with a lubricant in order to limit the generation of dust during transport and/or application. The lubricant can be any oil that does not affect the attractiveness of the granules. In this respect paraffin oil or diethyl phthalate may be mentioned by way of example. This precaution offers users greater convenience and safety.

It is also possible according to the invention to provide a step of sieving the granules in order to ensure absence of fine particles, fragments and dust.

It is also possible, after the step of drying the granules, and any other later step of the method, to provide spraying of a liquid adjuvant intended for example for olfactory repulsion in order to optimize storage of the granules. The granules can be stored by any usual method of storage, for example in silos.

The invention also relates to a bait that can be obtained by the method according to the invention as described above.

In general, but not indispensably, it is possible, for example after the sieving step, to pack the granules in 20 kg bags or in 10 kg boxes or in a flexible bulk container, for example on automated lines.

In order to limit the generation of dust during transport and application, the granules can also be lubricated. It is then a matter of spraying paraffin oil on the granules. Other lubricants can be used, such as diethyl phthalate or any other oil that does not affect the attractiveness of the granules.

Because they do not generate dust, these granules offer the user greater convenience and safety.

The bait according to the invention can be applied on crops by any means and in any form of spreading known to a person skilled in the art.

However, the inventors have demonstrated that on applying the bait according to the invention, particularly pyrethrum-based bait that is ploughed in, the efficacy for protection of seeds was increased considerably. In particular, using the bait according to the invention with ploughing in, it can constitute a barrier around the seed preventing pests reaching the latter. Thus, the active ingredient is under the best possible conditions as it is close to the seed and can even prevent its biochemical target reaching the seed. With this aim, their chances of contact with the target pest are increased by the formation of this barrier.

Unexpectedly, the applicant in fact found that the effect of bait according to the invention, particularly pyrethrum-based bait, was greatly increased when it was applied by ploughing in over the full width of the seed furrow in which the seed is placed, whether the crop is grown in furrows or in ridges. Applied in this way, the bait forms a barrier to soil insects, which can less easily attack and denature the seed, as well as the underground parts of the plant, once the seed has germinated and the seedling has started to grow. A greater effect of the active ingredient used, particularly of pyrethrum derivatives, is thus obtained when used in this way, in comparison with conventional means of application, especially when insecticides are applied in liquid form.

Another advantage is that the use of bait, because it is not captured by colloids in the soil (such as clay), poses less environmental risk. In fact, products used in liquid form, for example, can be captured by these soil colloids. There is then a risk of runoff under the action of heavy rain, which carries away the colloids and therefore the product to the rivers. Moreover, their sequestration makes them less bioavailable (contact between the product and the pest disturbed by the layers of colloid). This is not the case with bait.

The use of the bait according to the invention, advantageously of pyrethrum-based bait, with ploughing-in over the full width of the seed furrow is advantageous because the product, being present in the soil all around the seed, can have an effect all around the seed. Applied in this way, the efficacy of the products is increased relative to the liquid formulations.

Another advantage is that the doses of product applied can therefore be reduced, with a consequent decrease in their toxicity, both for the environment and for the person applying the product.

It is on the basis of these results that the inventors propose the use, with ploughing into the soil, of a bait comprising at least one active ingredient, advantageously pyrethrum and a support, and said bait can be in the form of granules.

Thus, the invention also relates to the use, with ploughing into the soil, of a bait comprising at least one active ingredient, advantageously pyrethrum, and a support.

According to a preferred embodiment, the invention relates to the aforementioned use, in a method of protection of a furrow crop against soil insects, which comprises the following steps:
a) a furrow is made in the soil;
b) the seed is placed on the earth at the bottom of the seed furrow formed by the furrow;
c) then the bait is spread over the full width of the seed furrow in which the seed has been placed; and
d) the furrow is covered with the earth prepared in step c).

According to a variant, the second and third steps of the method can be reversed.

According to yet another variant, the second and third steps can be simultaneous.

Thus, three orders of application are possible Either the seed is put on the earth, then the bait is applied, or vice versa. Another possibility is simultaneous application of seed and bait.

Preferably the bait is deposited first, then the seed.

According to the method, during creation of the furrow, an excavation in the form of a half cylinder is formed in the soil. Application of the bait over the whole surface of the excavation, before or after or at the moment of depositing the seed, makes it possible, during closure of the furrow, to create an insecticide barrier all around the seed, the latter being enveloped in a network of insecticide, which protects it from the soil insects, which are unable to reach it.

The invention also applies to ridge crops. In this case, the bait according to the invention, advantageously a pyrethrum-based bait, is applied on a surface of the soil above the surface occupied by the seed, before or after or at the moment of depositing the seed, and when the ridge is formed, the seed is enclosed in earth mixed with the insecticide bait, all around it, which protects it effectively against insect pests in the soil. The seed is therefore completely surrounded by the formulation comprising the active ingredient.

The invention also relates to a method of protection of a ridge crop against soil insects, which comprises the following steps:
a) the seed is placed on the earth,
b) then the bait comprising at least one active ingredient, advantageously pyrethrum, is deposited on an area equivalent to the largest circumference occupied by the seed,
c) a ridge is formed by covering the seed placed in a) with the earth prepared in the preceding step.

According to a variant, the first and the second step of the method of growing in a ridge can be reversed.

According to another variant, the first and the second step of the method of growing in a ridge can be simultaneous.

Preferably according to the invention, the bait is deposited first, then the seed.

The present invention therefore relates to a method for protecting seeds that offers the following advantages:
the bait is well distributed in the seed furrow over the full profile of the furrow. Thus, during closure of the furrow or creation of the ridge, the active compound is distributed all around the seed. The seed is thus protected against soil insects. The latter have greater difficulty in reaching the seed.
the use of the bait according to the invention with ploughing-in according to the invention is more effective closest to the seed, without being on the seed. The method according to the invention therefore optimizes protection of the seed without the drawbacks of coated seeds. It is understood that the insecticide, forming a barrier, kills a large number of soil insects trying to reach the seed. Because of this increased efficacy of the insecticide relative to the usual methods of application, the method is particularly advantageous in that it permits the use of lower doses of the active product,
the method according to the invention protects the seed, but also the underground parts of the plant following germination of the seed,
the farmer obtains a higher yield because fewer seeds are damaged,
the inventors have shown that the efficacy of the product is increased when using the method according to the invention, relative to a conventional method,
the method according to the invention can, moreover, be applied easily and quickly,
dispersion of insecticide in the environment is also limited. In fact, the method of application of the insecticide does not cause any spread or pollution on the surface of the soil, which avoids contamination of animals other than the animals living in the soil.

The method according to the invention can be used for all agricultural crops (cereals, market garden plants, horticultural plants, etc.). It is to be understood that the seeds and then the plant emerging from the seed are protected by the method according to the invention. It is preferably used for crops of maize, colza, sorghum, sunflower, potato, beetroot, carrot, cereals, cabbages, beans, melon, tomato, ornamental plants or even tobacco. Even more preferably, the invention applies to maize.

By “furrow” is meant a trench dug in the earth. The characteristics of the furrow are those usually used in agriculture, and vary depending on the seeds used, which the farmer will know how to adapt.

In furrows, better results will be obtained by incorporating the insecticides regularly at a depth at least greater than 1.5 cm, preferably greater than 2 cm. The width of the area of spread of the bait according to the invention, advantageously pyrethrum-based bait, in the furrow or in the ridge must be at least greater than the largest circumference occupied by the seed.

The method according to the invention can be used against all soil insects or parasites provided they are sensitive to the active ingredient used for preparation of the bait. There may be mentioned for example: click beetles, grey grubs, cockchafer larvae, noctuids, centipede, crane fly, black vine weevil, flies such as the seedling fly and the onion fly or the maize leaf beetle. Preferably the invention relates to the control of click beetles.

As the means of application of the insecticide compositions, it is possible to use applicators for solid formulations or applicators for powder. As applicator of solid formulations it is possible to use granule spreaders or small manually-operated devices for spreading granules such as pushed rotary spreaders for treating smaller areas. By powder applicators is meant for example devices for manual dusting or tractor-drawn powder-sprinklers. Preferably, application will be carried out with a diffuser, which can be installed at the end of the outlet tubes of a microgranulator. Advantageously said diffuser will be the applicants diffuser QUEUE-DE-CARPE DXP™. This diffuser can be fitted to the end of the outlet tubes of microgranulators particularly on disk drills, also on shoe drills using an installation kit, characterized in that it comprises a cylindrical or truncated body, hollow, open at both ends, one of said ends serving for fixing said diffuser to said outlet tubes of the microgranulator, and the other end being open on an inclined plane, of any shape, preferably of circular or oval shape, integral with said diffuser and having an angle with said diffuser between 35° and 55°, preferably between 40° and 50°. Advantageously said diffuser can further comprise a means of attachment to the outlet tube of the microgranulator. According to a variant, said means for attachment can be a screw positioned perpendicularly to the central axis of the cylinder or truncated cone forming said diffuser and passing through the wall of said cylinder or truncated cone. Such a diffuser can provide precise positioning of the pellets or granules of insecticide over the full width of the seed furrow.

Preferably, uses of the bait according to the invention with ploughing-in can be performed with this diffuser, advantageously a QUEUE-DE-CARPE DXP™ diffuser.

The invention also relates to a method of treatment of crops at the time of sowing, characterized in that bait comprising at least one active ingredient, advantageously pyrethrum, preferably according to one of the uses according to the invention, is ploughed into the soil.

The invention also relates to use of a diffuser such as described above for ploughing-in of solid insecticide bait according to the invention.

The invention further relates to a method of treatment of crops at the time of sowing, characterized in that it uses ploughing-in of bait according to the invention, preferably according to one of the uses described previously.

Other characteristics of the invention will become apparent from the examples given below, without the latter constituting any limitation of the invention.

### EXAMPLE 1

### Preparation of Bait According to the Invention Based on Cypermethrin in the Form of Granules, by the Method According to the Invention

Bait according to the invention is prepared, having the following composition

| | % w/w |
|---|---|
| Technical cypermethrin (Bayer Bilag (India), | 0.86 |
| guaranteed minimum content of 930 g/kg) | |
| Tixosil 38 ™ (RHODIA) | 0.74 |
| Blue dye (Hostaperm Blue B2G-KR) | 0.04 |
| Salicylic acid | 0.1 |
| Wheat flour (Q.S.) | 98.06 |
| Paraffin oil | 0.2 |
| TOTAL | 100 |

First a mixture is prepared from 53.76% of commercial cypermethrin (Bayer Bilag (India)) (guaranteed minimum content of 930 g/kg) and 46.24% of precipitated amorphous silica (Tixosil 38® (RHODIA)).

Then 1.6% of this mixture is mixed with 98.06% of wheat flour with addition of 0.1% of salicylic acid (RHODIA) and a sufficient quantity of blue dye (Hostaperm Blue B2G-KR (Clariant)) to obtain, by mixing, 100% of a composition in the form of bait that can be used according to the invention.

The bait thus obtained is then used for conducting tests of efficacy.

### EXAMPLE 2

### Controlling Click Beetles with Cypermethrin-Based Bait

The objective of this study is to evaluate the efficacy of the cypermethrin-based bait against click beetles.

The test was set up at LARREULE (64), a site that is characterized by a strong presence of click beetles (almost exclusively of the species Agriotes sordidus).

Sowing was carried out on Oct. 5, 2007 at a conventional depth (3-4 cm).

The target sowing density is 78000 feet/ha; the variety used is RIXXER® (R.A.G.T. Semences).

The soil is clay loam (of the “touyas” type) with a high level of organic matter (above 4%).

The site is not irrigated.

The meteorological conditions are particularly favourable to the surface activity of click beetles: temperatures are regularly above the seasonal normal value and the rainfall, regular to high during the first three months of the maize cycle, promotes moisture retention on the surface of the soil.

Factors investigated and methods of application

Seven sets of conditions were tested. In comparison with a reference of carbamate microgranules (CURATER®), a reference of pyrethroid microgranules (tefluthrin) (FORCE 1.5G®) and an untreated control, cypermethrin was tested in the form of insecticide bait granules: bait 1 and bait 2 at 12 kg Formulated Product (FP)/ha;

All of these sets of conditions were applied with a diffuser (except for CURATER®) positioning the granules on the whole surface of the seed furrow (SF). The insecticides used in the tests are:
E1: Control
E2: CURATER® (50 g active ingredient/kg) at 12 kg PC/ha (seed furrow SF);
E3: FORCE 1.5 G® (15 g active ingredient/kg) at 11.7 kg FP/ha (SF);
E4: Cypermethrin bait (composition from example 1 at 200 gr/g) at 12 kg FP/ha (SF) with diffuser,
E5: Cypermethrin bait from example 1 (composition from example 1 at 200 gr/g) at 12 kg FP/ha (SF) without diffuser;
E6: Cypermethrin bait 2 (composition from example 1 at 420 gr/g) at 12 kg FP/ha (SF) with diffuser;
E7: Cypermethrin bait 2 (composition from example 1 at 420 gr/g) at 12 kg FP/ha (SF) without diffuser;

The cypermethrin baits contain 8 g of active ingredient per kg of bait.

Conditions for Conducting the Test

Sowing is carried out with a NODET seed drill in 3 rows 0.80 m apart.

The unit plot comprises 3 rows on 20 m. The experiment uses a block device with 4 repetitions. The plots are distributed randomly within each block by means of SILENA software. The central row of 20 m is the subject of the observations.

The plot is weeded and fertilized by the farmer under his usual working conditions (pre-emergence weeding and localized supply of nitrogen between the rows at the 5-8 leaf step).

After setting up the test, the plots are monitored until the 11-leaf stage, for observations of the vegetation at the start of growing (extent of attack by click beetles), then they are monitored at harvest (proportion of plants with ear).

The timetable of interventions and observations was as follows:
Sowing: D0
Density at 2 leaves: D0+14
Observation 1: D0+21
Observation 2: D0+27
Observation 3: D0+35
Observation 4: D0+41
Number of ears: D0+90
Harvest: D0+137

Results

1.1. Effect of the Products on Attack at the Start of Vegetation

The level of attacks observed on the controls (E1) is high (70.8% at 11 leaves). The reference product (E2) based on carbofuran (CURATER®) shows a poor level of protection (40.8% plants attacked).

Finally, at 11 leaves, the results were as follows:
Very inadequate efficacy of the insecticides (based on cypermethrin) tested without diffuser (cf. conditions E5: 46.3% plants attacked; E7: 49.7% plants attacked), Application on the full width of the seed furrow—and not only at the bottom as for conventional microgranules of the carbamate type—is indispensable, for a pyrethroid-based product that is not mobile in the soil, for obtaining proper protection.
Interesting efficacy of the bait insecticides (E4 and E6) at 12 kg FP/ha, though tending to be lower than the insecticide FORCE 1.5G (however, no significant difference relative to these two last products).

It can therefore be concluded that the results are better when application is carried out with a diffuser.

TABLE 1
Kinetics of attack at the start of vegetation

| | E1 | E2 | E3 | E4 | E5 | E6 | E7 |
|---|---|---|---|---|---|---|---|
| doses | 0 | 12 | 11.7 | 12 | 12 | 12 | 12 |
| Density found at | 89.0 | 89.8 | 87.3 | 89.0 | 86.0 | 88.0 | 86.5 |
| 2-leaf step | | | | | | | |
| % of plants attacked | 70.8 | 40.6 | 5.6 | 12.7 | 46.3 | 14.6 | 49.7 |
| at the 11-leaf stage | | | | | | | |

1.2. Influence of Attacks on the Percentage of Plants Bearing at Least One Harvestable Ear (Ear with More than 70 Seeds):

The results obtained from monitoring the variables at the end of the maize cycle confirm the analysis based on the observations of attacks up to 11 leaves.

TABLE 2
Influence of attacks on the proportion
of plants with ears and on the yield.

| | E1 | E2 | E3 | E4 | E5 | E6 | E7 |
|---|---|---|---|---|---|---|---|
| doses | 0 | 12 | 11.7 | 12 | 12 | 12 | 12 |
| % of plants bearing | 70.7 | 82.3 | 95.6 | 91.8 | 76.0 | 90.7 | 78.5 |
| viable ears | | | | | | | |

The results obtained for the variable at the end of the maize cycle (proportion of harvestable ears) confirm the observations made at the start of vegetation. The efficacy of cypermethrin in the form of bait is better, for a similar dose of composition per hectare, as the dose of active ingredient per kg of composition is lower than for the other products tested (CURATER° and FORCE 1.5G®).

Conclusion

In this test with heavy infestation by click beetles (70% of plants attacked on the control).

The insecticide bait granules at a dose of 12 kg FP/ha localized by means of a diffuser show interesting potential for protection.

### EXAMPLE 3

### Evaluation of the Efficacy of the Cypermethrin-Based Bait at Different Doses Used in the Form of Granular Bait Against Click Beetles

The experiment was conducted at LARREULE (64).

This site is characterized by a strong presence of click beetles (almost exclusively Agriotes sordidus species).

Sowing was carried out on Oct. 5, 2007 at a conventional depth (3-4 cm). The sowing density adopted is 78000 feet/ha; the variety used is RIXXER®.

The soil is clay loam (“touyas” type) with a high level of organic matter (above 4%).

The plot is not irrigated.

The meteorological conditions are particularly favourable to the surface activity of click beetles: temperatures are regularly above the seasonal normal and the rainfall, regular to high during the first three months of the maize cycle, promotes the maintenance of moist conditions on the surface of the soil.

Factors investigated and methods of application

Nine sets of conditions were tested. In comparison with a reference of carbamate microgranules (CURATER®), a reference of pyrethroid microgranules (tefluthrin) (FORCE 1.5G®) and an untreated control, cypermethrin was tested in the form of insecticide bait granules: bait 1 and bait 2 at different doses (6, 9 and 12 kg FP/ha):

All of these sets of conditions were applied with a diffuser (except CURATER®) positioning granules on the whole surface of the seed furrow.

Products used, methods of application and doses
T1: Control
T2: CURATER® (50 g active ingredient/kg) at 12 kg PC/ha (seed furrow SF)
T3: FORCE 1.5 G® (15 g active ingredient/kg) at 11.7 kg FP/ha (SF) with diffuser
T4: cypermethrin bait 1 (200 gr/g) at 6 kg FP/ha (SF) with diffuser
T5: cypermethrin bait 1 (200 gr/g) at 9 kg FP/ha (SF) with diffuser
T6: cypermethrin bait 1 (200 gr/g) at 12 kg FP/ha (SF) with diffuser
T7: cypermethrin bait 2 (420 gr/g) at 6 kg FP/ha (SF) with diffuser
T8: cypermethrin bait 2 (420 gr/g) at 9 kg FP/ha (SF) with diffuser
T9: cypermethrin bait 2 (420 gr/g) at 12 kg FP/ha (SF) with diffuser

The cypermethrin baits contain 8 g of active ingredient/kg.

Conditions Far Conducting the Test

Sowing is carried out with a NODET seed drill in 3 rows 0.80 m apart. The unit plot comprises 3 rows on 20 m. The experiment uses a block device with 4 repetitions. The plots are distributed randomly within each block by means of SILENA software. The central row of 20 m is the object of the observations.

The plot is weeded and fertilized by the farmer under his usual working conditions (pre-emergence weeding and localized supply of nitrogen between the rows at the 5-6 leaf step).

After setting up the test, the plots are monitored until the 11-leaf stage for observations on the vegetation at the start of growing, then at harvest.

The timetable of the interventions and observations is as follows:
Sowing: D0
Density at 2 leaves: D0+14
Observation 1: D0+21
Observation 2: D0+27
Observation 3: D0+35
Observation 4: D0+41
Number of ears: D0+90
Harvest: D0+137

Results

1.1. Effect of the Products on Attacks at the Start of Vegetation

The level of attacks observed on the control (T1) is high (60.7% at 11 leaves). The reference product based on carbofuran (Curater, T2) shows a moderate level of protection (21% of plants attacked).

At the 11-leaf stage, the products investigated show levels of efficacy from moderate to very good. Baits 1 and 2 have very similar responses for one and the same dose.

Thus:
The doses of 6 kg (T4, T7) show levels of attack of 23.7% and 17.9% for bait 1 and 2 respectively.
The doses of 9 kg (T5, T8) provide similar protection, 7.3% and 7.5% respectively as level of attack for baits 1 and 2.
The doses of 12 kg (T6, T9) are also similar, respectively 9.1% and 11.4% of plants attacked for baits 1 and 2.

TABLE 3
Kinetics of attack at the start of vegetation

| product | T1 | T2 | T3 | T4 | T5 | T6 | T7 | T8 | T9 |
|---|---|---|---|---|---|---|---|---|---|
| doses | | 12 | 11.7 | 6.0 | 9.0 | 12.0 | 6.0 | 9.0 | 12.0 |
| % of plants | 60.7 | 21.0 | 8.9 | 23.7 | 7.3 | 9.1 | 17.9 | 7.5 | 11.4 |
| attacked at | | | | | | | | | |
| the 11-leaf | | | | | | | | | |
| stage | | | | | | | | | |

The results show:
correct results with bait insecticides 1 and 2 in the form of granules applied with a diffuser at doses of 9 and 12 kg EP/ha.
inferior results with the two baits at 6 kg FP/ha even if statistically these doses are in the same group as the preceding 2 doses.

1.2. Influence of Attacks on the Proportion of Plants Bearing at Least One Harvestable Ear (Ear with More than 70 Seeds)

TABLE 4
Influence of attacks on the yield

| | T1 | T2 | T3 | T4 | T5 | T6 | T7 | T8 | T9 |
|---|---|---|---|---|---|---|---|---|---|
| doses | | 12 | 11.7 | 6.0 | 9.0 | 12.0 | 6.0 | 9.0 | 12.0 |
| % of plants bearing | 60.0 | 83.6 | 95.2 | 80.0 | 88.9 | 84.9 | 87.3 | 91.3 | 88.2 |
| viable ears | | | | | | | | | |

The results obtained for the variable at the end of the maize cycle (% harvestable ears) confirm the observations of the attacks up to the 11-leaf stage.

In this test, with heavy infestation by click beetles (60% of plants attacked for the control), the bait insecticides applied by diffuser show interesting efficacies starting from a dose of 9 kg FP/ha.

The efficacy of the insecticide baits is more interesting in that, for a similar dose of composition per hectare (12 kg FP/ha), the dose of the active ingredient per kg of composition is lower than in the case of the reference products (CURATER® and FORCE 1.5G®).

1. Solid insecticide bait in the form of granules, comprising at least one active ingredient and a support.

2. Bait according to claim 1, wherein the active ingredient is selected from pyrethrum, the neonicotinoids (for example thiamethoxam, clothianidine), chloronicotiniles (for example acetamiprid, imidacloprid, thiacloprid), spinosoids (for example spinosad), pyridine-azomethrins (for example pyrimetrozine), pyridine-carboxamides (for example flonicamid), azadirectins, and said compounds can be natural or synthetic, their isomers or mixtures of isomers, whether natural or synthetic.

3. Bait according to claim 1, wherein the active ingredient is selected from pyrethrum per se, pyrethrins and/or pyrethroids, advantageously natural pyrethrum or cypermethrin.

4. Bait according to claim 3, wherein the synthetic pyrethroids can be selected from acrinathrin, bifenthrin, bioresmethrin, alphametrine, deltamethrin, depallethrin, etofenprox, fenpropathrin, cypermethrin, fenvalerate, esfenvalerate, cyfluthrin, betacyfluthrin, betacypermethrin, tralomethrin, fluvalinate, tau-fluvalinate, permethrin, lambda-cyhalothrin, flucythrinate, tefluthrin, zetacypermethrin.

5. Bait according to claim 1, wherein the support is of wheat flour or bran flour or durum wheat flour or maize flour.

6. Bait according to claim 1, wherein it comprises active ingredient in a proportion between 2 and 12 g per kg of composition, preferably between 6 and 10 g per kg of composition, and very preferably between 7 and 9 g per kg of composition.

7. Bait according to claim 1, wherein it comprises a support in a proportion between 800 and 998 g per kilogram of composition, preferably between 900 and 990 g/kg, and very preferably between 975 and 985 g/kg.

8. Bait according to claim 1, wherein the bait has a diameter between 0.5 and 3 mm, preferably between 1 and 2 mm, and very preferably a diameter of 1.6 mm.

9. Bait according to claim 1, wherein the bait has an apparent density between 0.40 and 1, preferably between 0.60 and 0.90.

10. Method of production of a bait comprising at least one active ingredient, advantageously a pyrethrum, and a support in which
in a first step a premix of active ingredient is prepared with an absorption filler;
in a second step an extrudable paste comprising the active ingredient is prepared with the premix obtained in step 1;
in a third step said paste obtained in step 2 is extruded and chopped to obtain the bait in the desired form of granules;
in a fourth step the granules obtained in step 3 are dried.

11. Method according to claim 10, wherein it further comprises a fifth step during which the dry granules obtained in step 4 are cooled.

12. Method according to claim 10, wherein it comprises a sixth step during which the cooled granules obtained in step 5 are lubricated.

13. Method according to claim 10, wherein in step 1, a premix is prepared comprising the active ingredient, advantageously pyrethrum, in an quantity in the pure state between 25 and 75%, preferably between 45 and 55%, advantageously equal to 50% by weight of the total weight of the premix.

14. Method according to claim 10, wherein step 2 comprises
a substep 2a) of preparation of a solid mixture comprising the premix obtained in step 1 and the other ingredients included in the final composition of the bait, including in particular the support;
a substep 2b) of moistening of the solid mixture obtained in substep 2a);
a substep 2c) of kneading of the product obtained in step 2b) to obtain the extrudable paste in step 3 of the method.

15. Method according to claim 14, wherein in substep 2b the moistening agent is water or steam.

16. Method according to claim 15, wherein when the moistening agent is steam, the latter is introduced directly in step 3.

17. Method according to claim 14, wherein the moistening agent is at a temperature between ambient temperature and 90° C., preferably between 30 and 60° C.

18. Bait that can be obtained by the method as described in claim 10.

19. A method of protecting a crop against insects, comprising ploughing a bait into the soil, the improvement wherein the bait is a solid insecticide bait in accordance with claim 1 comprising at least one active ingredient, advantageously pyrethrum, and a support.

20. The method according to claim 19, wherein the method provides protection of a furrow crop against soil insects and comprises the following steps:
a) a furrow is made in the soil;
b) the seed is placed in earth at the bottom of the seed furrow formed by the furrow,
c) then said solid insecticide bait, comprising at least pyrethrum, is spread over the full width of the seed furrow in which the seed was placed;
d) the furrow is closed with the earth prepared in step c).

21. The method according to claim 19, wherein the method provides protection of a ridge crop against soil insects and comprises the following steps:
a) the seed is placed on the earth;
b) then said solid insecticide bait, comprising at least pyrethrum, is deposited on an area equivalent to the area occupied by the largest circumference of the seed; and
c) a ridge is formed by covering the seed placed in a) with the earth prepared in step b).

22. The method according to claim 19, wherein the seed is a seed of maize, colza, sorghum, sunflower, potato, beetroot, carrot, cereals, cabbages, beans, melon, tomato, ornamental plants or even tobacco, preferably a seed of maize.

23. The method according to claim 19, wherein the soil insects are selected from the group consisting of click beetle, grey grubs, cockchafer larvae, noctuids, centipede, crane fly, black vine weevil, flies such as the seedling fly and the onion fly and the maize leaf beetle, preferably the click beetle.

24. The method according to claim 19, wherein the composition is used at a dose in the range from 2 to 20 kg/ha, preferably from 9 to 15 kg/ha, and very preferably from 12 kg/ha.
